(19) United States
(12) Patent Application Publication
(10) Pub. No.: US 2012/0051698 A1
(43) Pub. Date: Mar. 1, 2012

(54) Optical Fiber Terminus

(75) Inventors: James T. HALL, Bainbridge, NY (US); John H. MIKOLAICYK, Oneonta, NY (US)

(73) Assignee: AMPHENOL CORPORATION, Wallingford, CT (US)

(21) Appl. No.: 12/869,079

(22) Filed: Aug. 26, 2010

(51) Int. Cl. G02B 6/36

(52) U.S. Cl. 385/84

(57) ABSTRACT

An optical fiber terminus that comprises a one-piece body that comprises an inner tube that defines an inner bore configured to receive an optical fiber. The inner tube has first and second opposite ends and is configured to allow insertion of the optical fiber at the first end. An outer spring member substantially surrounds the inner tube. The outer spring member has first and second end sections and an intermediate section therebetween. The intermediate section has a plurality of windows which expose portions of the inner tube. When a force is applied to the first end of the inner tube, the windows of the outer spring member are compressible such that the windows collapse.

### FIELD OF THE INVENTION

The present invention relates to a terminus for an optical fiber. More specifically, the terminus is molded as one-piece and is configured to accept a plastic optical fiber.

### BACKGROUND OF THE INVENTION

It is conventional to couple an optical fiber cable to an optical device or other optical fiber cables through a connector that incorporates a ferrule for receiving the optical fiber. A plastic optical fiber cable is typically formed of a plastic optical fiber core and a plastic sheath covering the core. The plastic sheath must be stripped, as is known in the art, to be coupled with a ferrule. Conventional ferrules, however, often cannot accommodate a plastic optical fiber because they are designed to receive a glass optical fiber. That is, because the diameter of a plastic optical fiber is larger than the diameter of a glass optical fiber, conventional ferrules cannot receive the larger plastic optical fiber.

Moreover, conventional optical fiber connectors require several components to support the optical fiber including at least a ferrule and a separate spring element. Because conventional ferrules are typically made of a hard material, such as ceramic, integration of a spring element is not possible. The requirement for multiple optical fiber components, including a separate spring, greatly increases the complexity of assembling the optical fibers in the connectors.

### SUMMARY OF THE INVENTION

Accordingly, the present invention provides an optical fiber terminus that comprises a one-piece body that comprises an inner tube that defines an inner bore configured to receive an optical fiber. The inner tube has first and second opposite ends and is configured to allow insertion of the optical fiber at the first end. An outer spring member substantially surrounds the inner tube. The outer spring member has first and second end sections and an intermediate section therebetween. The intermediate section has a plurality of windows which expose portions of the inner tube. When a force is applied to the first end of the inner tube, the windows of the outer spring member are compressible such that the windows collapse. In at least one embodiment, the optical fiber is preferably a plastic optical fiber.

The present invention may also provide a connector that comprising an outer shell, an insert body received in the outer shell where the insert body has at least one passageway, and at least one terminus received in the passageway. The terminus has an inner tube that defines an inner bore configured to receive an optical fiber. The inner tube has first and second opposite ends and is configured to allow insertion of the optical fiber at the first end. An outer spring member substantially surrounds the inner tube. The outer spring member has first and second end sections and an intermediate section therebetween. The intermediate section has a plurality of windows which expose portions of the inner tube, whereby when a force is applied to the first end of the inner tube, the windows of the outer spring member compress such that the windows collapse.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a terminus according to an embodiment of the present invention;

FIG. 2 is a partial cross-sectional view of a connector supporting the terminus illustrated in FIG. 1;

FIG. 3 is a perspective view of the connector illustrated in FIG. 2 with a portion of the connector cut away to show the terminus of the present invention;

FIG. 4A is a side elevational view of the terminus illustrated in FIG. 1, showing the terminus in a relaxed state; and

FIG. 4B is a side elevational view similar to FIG. 4A, showing the terminus in a compressed state.

### DETAILED DESCRIPTION OF THE PREFERRED EMBODIMENT

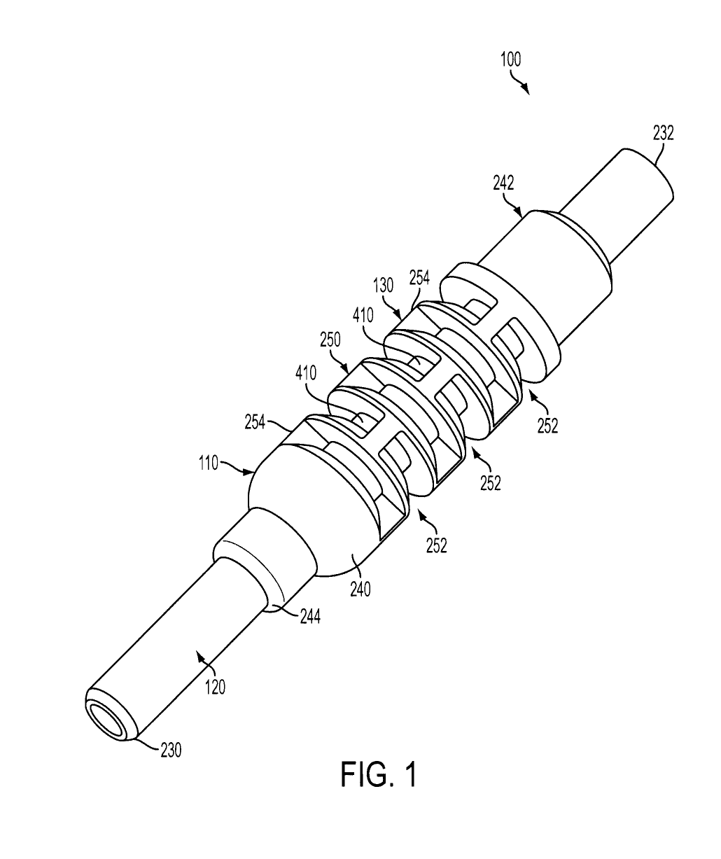

Referring to FIGS. 1-3, 4A and 4B, the present invention generally relates to a terminus 100 for terminating an optical fiber. The terminus 100 of the present invention has a simplified one-piece molded design that can accommodate a plastic optical fiber in addition to the conventional glass optical fiber. As best seen in FIG. 1, the terminus 100 generally has a one-piece body 110 including an inner tube 120 for receiving the optical fiber and an outer spring member 130 disposed around the inner tube 120. The terminus 100 may be made of a plastic material, such as a flexible polymer.

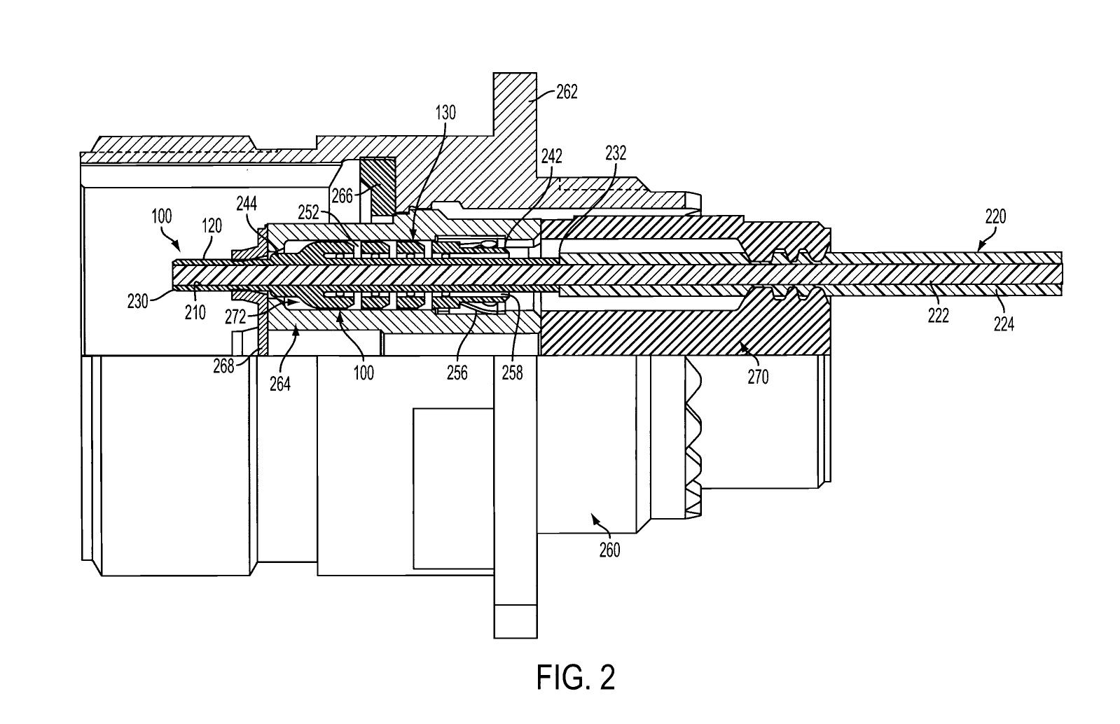

The inner tube 120 may include an inner bore 210 sized and shaped to receive a plastic optical fiber, as seen in FIG. 2. The inner bore 210 preferably has an inner diameter that is substantially the same or slightly larger than the outer diameter of a plastic optical fiber core 222 of a fiber cable 220 for a slip fit between the two components. The optical fiber 220 is bonded to the inner surface of the inner bore 210, such as by use of any epoxy. The inner tube 120 has a first end 230 and an opposite second end 232 through which the optical fiber 220 is inserted.

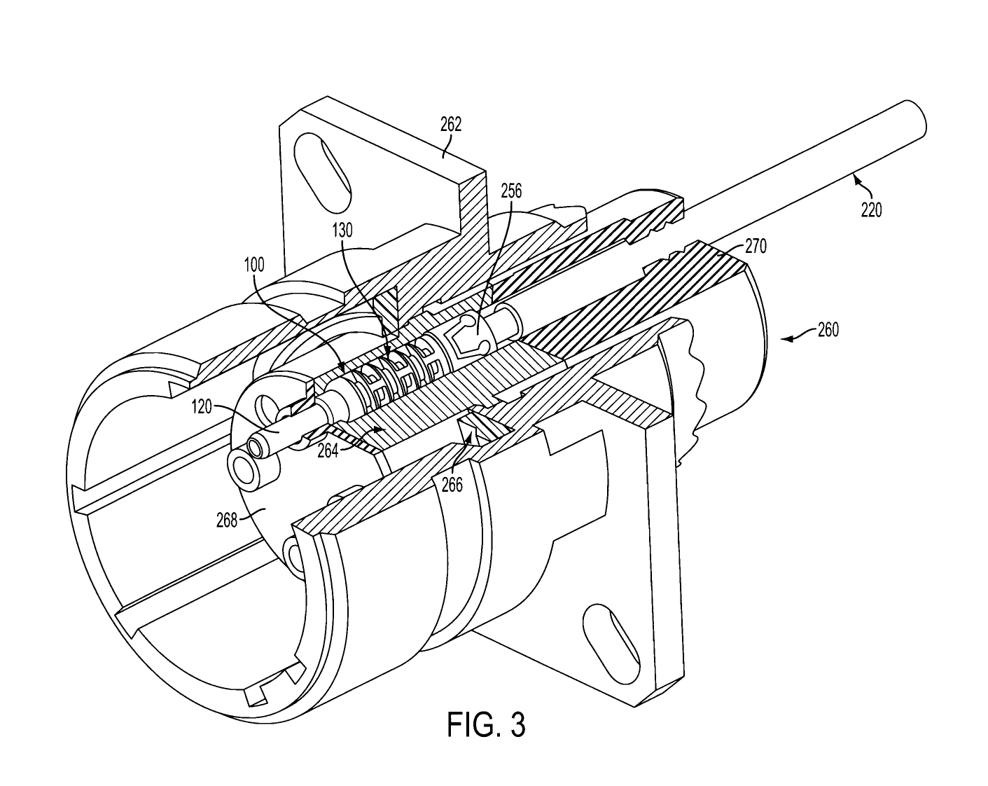

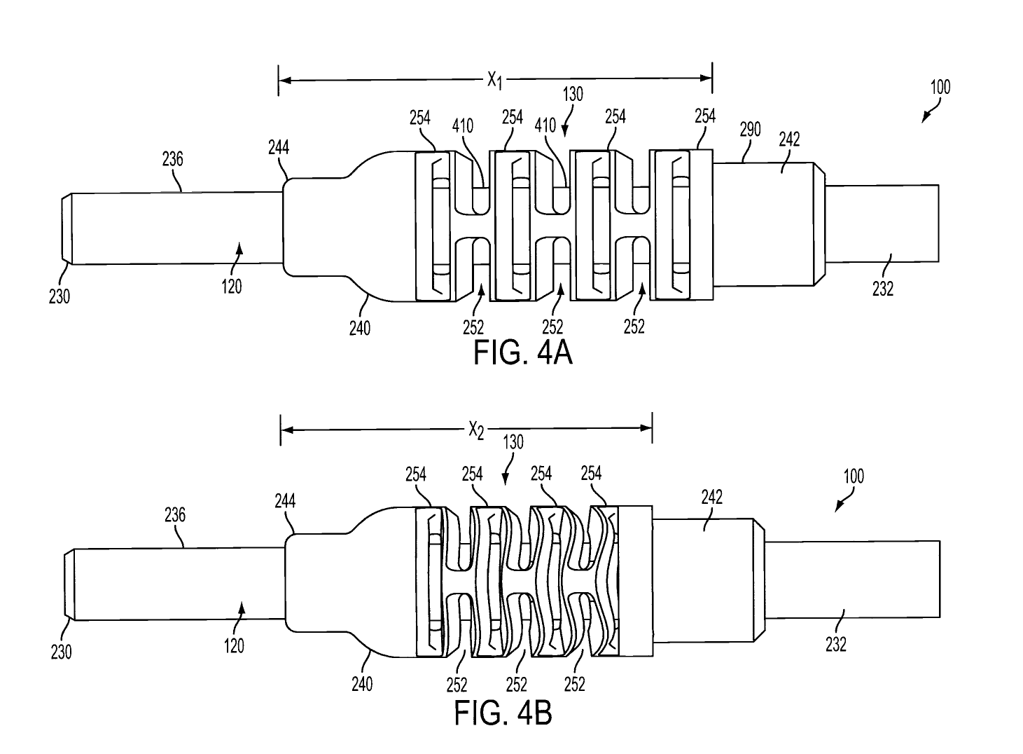

The outer spring member 130 extends around a middle portion of the inner tube 120. As best seen in FIGS. 1, 4A and 4B, the outer spring member 130 includes a first end section 240 that joins to the outer surface of the inner tube 120 to form a generally frusto-concial section of the terminus 100. An abutment shoulder 244 at the distal end of first end section 240 extends around an outer surface 236 of the inner tube. Opposite the first end section 240 is a second end section 242 that is free or spaced from the inner tube 120 and is shaped to mate with a retaining clip 256 (FIGS. 2 and 3). An intermediate section 250 of the outer spring member 130 includes a plurality of annular windows 252 defined between annular sections 254 of the spring member 130, as best seen in FIGS. 1, 4A and 4B. As seen in FIGS. 2 and 4A, the windows 252 of the outer spring member 130 are open and expose portions 410 of the outer surface of the inner tube 120.

Between the inner tube 120 and the outer spring member 130 is an annular space 258 (FIG. 2) that allows the outer spring member 130 to compress with respect to the inner tube 120, as best seen in FIG. 4B. That is, when a force is applied to the first end 230 of the terminus' inner tube 120 and the second end 232 is fixed, the windows 252 are designed to collapse, as seen in FIG. 4B. When the force is applied to the terminus 100, the outer spring member 130 compresses with respect to the inner tube 120 such that the distance or length X₁ of the outer spring member 130 decreases from its relaxed state, as seen in FIG. 4A, to its compressed state (length X₂), as seen in FIG. 4B. That is X₂ is less than X₁. The overall length of the terminus 100, however, does not change between the springs's relaxed and compressed states, thereby eliminating compressive forces applied to the fiber.

Referring to FIGS. 2 and 3, a connector 260 may support one or more termini 100 of the present invention. In general, the connector 260 includes an outer connector shell 262, an inner insert body 264 for supporting at least one terminus 100, a main joint gasket seal 266, and interfacial seal 268 and a grommet 270. The outer connector shell 262 is preferably metal as well as the insert body 264. The insert body may also be plastic. The main joint gasket seal 266 may be plastic or rubber and provides a seal between the connector 260 and its mating connector (not shown). The interfacial seal 268 is applied to the end of the insert body 264.

The plastic optical fiber cable 220 includes the plastic optical fiber core 222 and an outer protective jacket 224. The optical fiber 220 extends through a passageway 272 of the insert body 264. Multiple passageways may be provided in the insert body 264 to support more than one terminus 100. In the passageway 272, the abutment shoulder 244 of the terminus 100 may abut the interfacial seal 268, as best seen in FIG. 2. At the opposite end of the insert body 264 and passageway 272, a recessed area 290 is provided that receives the arms of the retaining clip 256 to retain the terminus 100 within the passageway 272. The grommet 270 adjacent the insert body 264 provides sealing on the outside diameter of the cable and some strain relief to the cable, as is well known in the art.

As illustrated, the connector 260 is a receptacle connector that receives a mating plug connector (not shown), which preferably also supports at least one terminus 100. The connector 260, however, may have either a receptacle or plug interface. When the connectors are mated, a force is applied to the termini. More specifically, a force is applied to the first end 230 of each terminus 100 of connector 260 (with their second ends 232 retained by clips 256 in the connector), thereby compressing the outer springs 130 of each terminus such that the windows collapse 252, as described above and seen in FIG. 4B. This compression keeps the ends of mating optical fibers in positive contact for better light transmission.

While a particular embodiment has been chosen to illustrate the invention, it will be understood by those skilled in the art that various changes and modifications can be made therein without departing from the scope of the invention as defined in the appended claims. For example, the terminus 100 may be adapted to support a glass optical fiber by replacing the inner tube 120 of the terminus 100 with a ceramic ferrule that fits a glass optical fiber.

What is claimed is:

1. An optical fiber terminus, comprising of:
a one-piece body that comprises:
an inner tube defining an inner bore configured to receive an optical fiber and said inner tube having first and second opposite ends, said inner tube being configured to allow insertion of the optical fiber at said first end; and
an outer spring member substantially surrounding said inner tube, said outer spring member having first and second end sections and an intermediate section therebetween, said intermediate section having a plurality of windows which expose portions of said inner tube,
whereby when a force is applied to said first end of said inner tube, said windows of said outer spring member being compressible such that said windows collapse.

2. An optical fiber terminus according to claim 1, wherein
said outer spring member is movable between a compressed state and a relaxed state with respect to said inner tube.

3. An optical fiber terminus according to claim 2, wherein
said terminus has a length and said length remains the same when the outer spring member moves between said relaxed and compressed states.

4. An optical fiber terminus according to claim 2, wherein
an annular space is located between said inner tube and said outer spring member.

5. An optical fiber terminus according to claim 4, wherein
said first end section of said outer spring member is joined to said inner tube.

6. An optical fiber terminus according to claim 5, wherein
said inner tube includes an abutment shoulder between said first end of said inner tube and said outer spring member.

7. An optical fiber terminus according to claim 6, wherein
said second end section of said outer spring member includes an outer recessed area configured to mate with a retaining clip.

8. An optical fiber terminus according claim 1, wherein
said optical fiber is a plastic optical fiber.

9. An optical fiber terminus according claim 8, wherein
said inner bore of said inner tube is sized to received said plastic optical fiber.

10. A connector, comprising of:
an outer shell;
an insert body received in said outer shell, said insert body having at least one passageway; and
at least one terminus received in said passageway, said terminus having an inner tube defining an inner bore configured to receive an optical fiber, said inner tube having first and second opposite ends, said inner tube being configured to allow insertion of the optical fiber at said first end, and an outer spring member substantially surrounding said inner tube, said outer spring member having first and second end sections and an intermediate section therebetween, said intermediate section having a plurality of windows which expose portions of said inner tube, whereby when a force is applied to said first end of said inner tube, said windows of said outer spring member being compressible such that said windows collapse.

11. A connector according to claim 10, wherein
said terminus is a one-piece body.

12. A connector according to claim 10, wherein
said passageway of said connector receives a retaining clip; and
said retaining clip mates with said second end section of said outer spring member.

13. A connector according to claim 10, wherein
said outer spring member of said terminus is movable between a compressed state and a relaxed state with respect to said inner tube.

14. An optical fiber terminus according to claim 13, wherein
said terminus has a length and said length remains the same when the outer spring member moves between said relaxed and compressed states.

15. A connector according to claim 13, wherein
an annular space is located between said inner tube and said outer spring member allowing said outer spring member to compress with respect to said inner tube.

16. A connector according to claim 15, wherein
said first end section of said outer spring member is joined to said inner tube.

17. A connector according to claim 16, wherein
said inner tube includes an abutment shoulder between said first end of said inner tube and said outer spring member.

18. A connector according to claim 10, wherein
said optical fiber is a plastic optical fiber.

19. A connector according to claim 18, wherein
said inner bore of said inner tube is sized to received said plastic optical fiber.
